(19) United States
(12) Patent Application Publication
(10) Pub. No.: US 2014/0072937 A1
(43) Pub. Date: Mar. 13, 2014

(54) SYSTEM AND METHOD OF TESTING CANDIDATES' SKILL OF USE OF CUTTING TOOLS AND COMPILING AND MANAGING DATA RELATED TO CANDIDATES' TEST RESULTS AND PROVIDING DATA TO POTENTIAL EMPLOYERS

(71) Applicant: William E. Simpson, II, Portland, OR (US)

(72) Inventor: William E. Simpson, II, Portland, OR (US)

(21) Appl. No.: 14/025,631

(22) Filed: Sep. 12, 2013

Related U.S. Application Data
(60) Provisional application No. 61/700,716, filed on Sep. 13, 2012.

(51) Int. Cl. G09B 7/06

(52) U.S. Cl. CPC G09B 7/06
USPC 434/219

(57) ABSTRACT

A system for remote communication of information relating to cutting operations includes a template that is configured for cutting by a person. The template includes an indication that indicates a predetermined path for cutting of the template. The system also includes a first computerized device having an input device configured to input cutting information. The cutting information relates to cutting of the template along the predetermined path. The system also includes a second computerized device that is remote from the first computerized device. The second computerized device is configured to receive the cutting information. Moreover, the system includes a communications device configured to provide communication between the first computerized device and the second computerized device to allow the cutting information to be sent from the first computerized device to the second computerized device.

### CROSS-REFERENCE TO RELATED APPLICATION

This application claims to priority to U.S. Provisional Patent Application Ser. No. 61/700,716, filed Sep. 13, 2012, the disclosure of which is hereby incorporated by reference.

### FIELD

The present disclosure relates to the use of cutting tools and, more particularly, to a system and method of testing candidates' use of cutting tools and providing test results to potential employers.

### BACKGROUND

This section provides background information related to the present disclosure and is not necessarily prior art.

Cutting tools are used for cutting various objects. For instance, scissors are used for trimming plant material, for cutting hair, and for other purposes. Some people can be especially skilled in using these cutting tools for these and other purposes. Employers typically seek out candidates that are especially dexterous, accurate, and quick when cutting objects using these tools. However, it can be time consuming, difficult, and otherwise inconvenient for employers to find suitable candidates for cutting operations.

### SUMMARY

A system for remote communication of information relating to cutting operations is disclosed. The system includes a template that is configured for cutting by a person. The template includes an indication that indicates a predetermined path for cutting of the template. The system also includes a first computerized device having an input device configured to input cutting information. The cutting information relates to cutting of the template along the predetermined path. The system also includes a second computerized device that is remote from the first computerized device. The second computerized device is configured to receive the cutting information. Moreover, the system includes a communications device configured to provide communication between the first computerized device and the second computerized device to allow the cutting information to be sent from the first computerized device to the second computerized device.

Moreover, a method of remotely communicating information relating to cutting operations is disclosed. The method includes providing a template, wherein the template includes an indication that indicates a predetermined path for cutting the template. Also, the method includes receiving cutting information by a first computerized device. The cutting information relates to cutting of the template by a first person along the predetermined path. Furthermore, the method includes transferring the cutting information from the first computerized device to a second computerized device that is remote from the first computerized device. Also, the method includes outputting the cutting information from the second computerized device.

Still further, a method of remotely communicating information relating to cutting operations is disclosed. The method includes providing a first candidate computer, a second candidate computer, and at least one employer computer. The first and second candidate computers are in remote communication with the at least one employer computer. The first candidate computer includes a first input device, the second candidate computer includes a second input device, and the at least one employer computer includes an output device. The method further includes providing a first template to a first candidate and a second template to a second candidate. The first and second templates both include an indication that indicates a predetermined path for cutting the respective template. Moreover, the method includes allowing the first candidate to cut the first template along the predetermined path and allowing the second candidate to cut the second template along the predetermined path. Also, the method includes receiving, by the first input device of the first candidate computer, a first cutting information and a first identifier of the first candidate. The first cutting information relates to cutting of the first template by the first candidate along the predetermined path. Moreover, the method includes associating the first identifier with the first cutting information to create a first profile of the first candidate. Also, the method includes receiving, by the second input device of the second candidate computer, a second cutting information and a second identifier of the second candidate. The second cutting information relates to cutting of the second template by the second candidate along the predetermined path. Additionally, the method includes associating the second identifier with the second cutting information to create a second profile of the second candidate. Furthermore, the method includes transferring the first profile and the second profile to the at least one employer computer. Also, the method includes outputting at least one of the first profile and the second profile using the output device of the at least one employer computer.

Other systems, methods, features and advantages of the present disclosure will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The drawings described herein are for illustrative purposes only of selective embodiments and not all possible implementations, and are not intended to limit the scope of the present disclosure.

FIG. 1 is a schematic view of a system for testing candidates' use of cutting tools and for providing test results to potential employers according to exemplary embodiments of the present disclosure;

FIG. 2 is a plan view of a testing template that can be used in the system of FIG. 1;

FIG. 3 is a plan view of the testing template of FIG. 2 shown after being cut;

FIG. 4 is a schematic view of a portion of the cut testing template of FIG. 2 shown in comparison with the original cut line indicated on the template; and

FIG. 5 is a flowchart illustrating methods of testing candidates, providing test results to potential employers, and identifying suitable candidates to the potential employers using the system of FIG. 1.

Corresponding reference numerals indicate corresponding parts throughout the several views of the drawings.

### DETAILED DESCRIPTION

Example embodiments will now be described more fully with reference to the accompanying drawings.

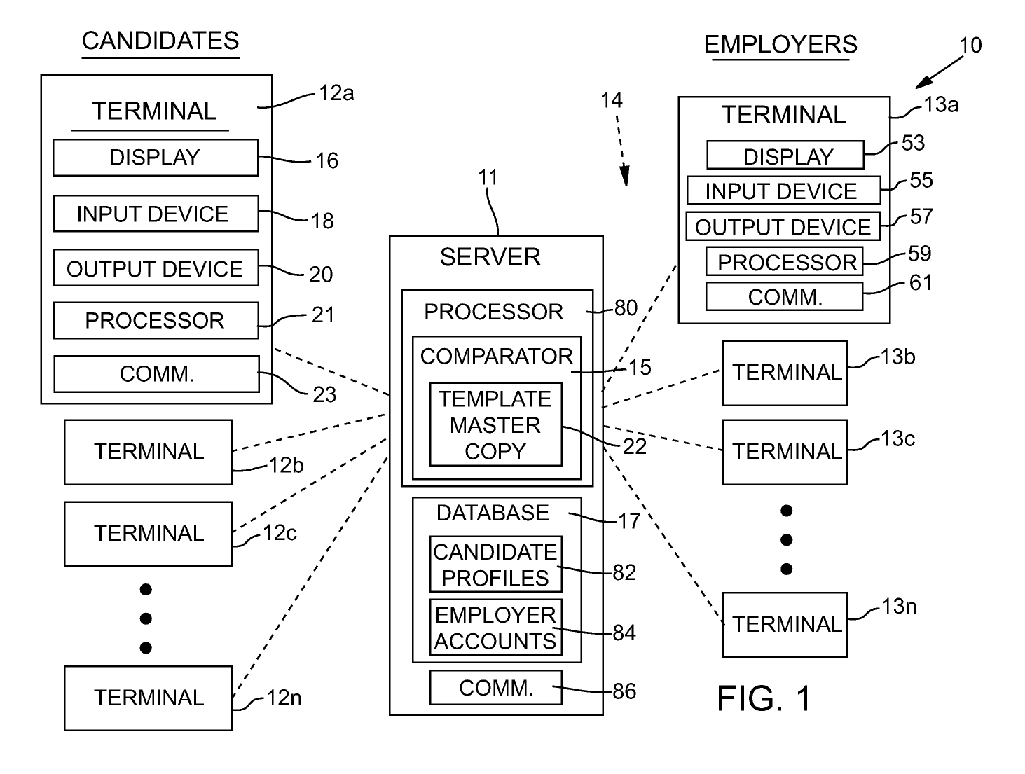

Referring initially to FIG. 1, a system 10 for testing candidates' use of cutting tools and for providing test results to potential employers is illustrated. It will be appreciated that the system 10 could be used for testing use of any cutting tool, such as scissors, knives, shears, etc. Also, the system 10 could be used for testing cutting of any material, such as plant-based material, hair, or other type of cuttable material. Moreover, the system 10 could be used in ways other than for providing communications between candidates and employers without departing from the scope of the present disclosure. Additionally, the system 10 could be configured for testing the use of tools other than cutting tools in some embodiments.

The system 10 can include one or more first computerized devices, such as terminals 12a, 12b, 12c, 12n. It will be appreciated that the system 10 can include any suitable number of first terminals 12a, 12b, 12c, 12n, and in some embodiments, the system 10 can include only one first terminal.

The system 10 can also include one or more second computerized devices, such as terminals 13a, 13b, 13c, 13n. It will be appreciated that the system 10 can include any suitable number of second terminals 13a, 13b, 13c, 13n, and in some embodiments, the system 10 can include only one second terminal.

Each of the terminals 12a, 12b, 12c, 12n, 13a, 13b, 13c, 13n can be in communication with each other and in communication with a computerized server 11 via a computerized network 14 (e.g., the Internet, an intranet, or other network). In some embodiments, the system 10 can be at least partially embodied on a dedicated website of the world wide web.

In some embodiments, the terminals 12a, 12b, 12c, 12n can be used by candidates (e.g., those looking for work using certain cutting tools), and the terminals 13a, 13b, 13c, 13n can be used by potential employers for evaluating the candidates, for searching for potential candidates, providing feedback about certain candidates, or other uses. Thus, the terminals 12a, 12b, 12c, 12n can be referred to as “candidate terminals,” and the terminals 13a, 13b, 13c, 13n can be referred to as “employer terminals.” However, it will be appreciated that this is merely an example of the type of use for the system 10 and the system 10 could be used in other scenarios without departing from the scope of the present disclosure.

In some embodiments, the terminals 12a, 12b, 12c, 12n can be personally owned or publically accessible computerized devices. These terminals 12a, 12b, 12c, 12n can also be located in publicly accessible locations, such as stores, bars, restaurants, co-ops, or other public spaces. In additional embodiments, the terminals 12a, 12b, 12c, 12n can be embodied on personally owned computers, cell phones, computerized-tablets, etc. The terminals 13a, 13b, 13c, 13n can be similarly embodied. For example, the terminals 13a, 13b, 13c, 13n can be embodied on personally owned or publicly accessible computers, cell phones, computerized-tablets, etc.

The network 14 can provide secure communications (e.g., via encryption, password protection, etc.) between the terminals 12a-13n and server 11. The network 14 can further allow cloud based computing, or the network 14 can be configured such that one or more of the terminals 12a-13n engage in local processing and computing.

Moreover, although the system 10 illustrated in FIG. 1 provides remote electronic communications between the terminals 12a-13n and server 11, it will be appreciated that some of the communication between users of the system 10 can occur otherwise. For instance, at least some communications can occur via the shipment of hard-copy documents or other materials through government mail services and/or private shipping services. Additionally, in some embodiments, the system 10 can provide communications between at least one of the terminals 12a-12n and at least one of the terminals 13a-13n without the server 11 acting as an intermediary device. For example, the functions of the server 11 could be performed by one of the terminals 13a-13n and/or the components of the server 11 could be included on one of the terminals 13a-13n.

The terminal 12a will now be discussed in more detail. The other terminals 12b, 12c, 12n can be similar to the terminal 12a as described below.

The terminal 12a can include a display 16 (e.g., a computer screen) that can display text, pictures, and other objects thereon. The terminal 12a can also include one or more input devices 18 (e.g., a keyboard, a computer mouse, etc.) that can be used to input identifying information, control commands, etc. Additionally, the terminal 12a can include one or more output devices 20 (e.g., a printer, etc.) that can be used to output hard copies of testing materials and the like. Furthermore, the terminal 12a can include a processor 21 for performing calculations, for generating control commands, etc. Additionally, the terminal 12a can include a communication device 23 that allows for two-way communications between the terminals 12a-13n and/or the server 11.

The terminal 13a can be similar to the terminal 12a in some embodiments. Thus, the terminal 13a can include a display 53 (e.g., a computer screen) that can display text, pictures, and other objects thereon. The terminal 13a can also include one or more input devices 55 (e.g., a keyboard, a computer mouse, etc.) that can be used to input identification information, control commands, etc. Additionally, the terminal 13a can include one or more output devices 57 (e.g., a printer, etc.) that can be used to output hard copies of various materials. Furthermore, the terminal 13a can include a processor 59 for performing calculations, for generating control commands, etc. Additionally, the terminal 13a can include a communication device 61 that allows for two-way communications between the terminals 12a-13n and/or the server 11. The other terminals 13a, 13b, 13c, 13n can be similar to the terminal 13a in some embodiments.

The server 11 can enable communications between the terminals 12a-12n and the terminals 13a-13n. In some embodiments, the server 11 can be accessible via an internet webpage. Specifically, the server 11 can include a communications device 86 that allows communication with the terminals 12a-12n and/or the terminals 13a-13n. Also, the server 11 can include a processor 80. In some embodiments, the processor 80 can include a comparator 15. The comparator 15 can compare information (e.g., testing or cutting information) submitted by persons using the terminals 12a-12n with predetermined information. In some embodiments, the comparison can occur automatically. In other embodiments, the comparison can be performed manually. Additionally, the server 11 can include memory, such as RAM or ROM, and a database 17 can be saved thereon. The database 17 can store one or more candidate profiles 82 and/or one or more employer accounts 84. As will be discussed, the candidate profile 82 can include information relating to particular candidates, and the employer accounts 84 can include information relating to particular employers. For example, the candidate profile 82 can include a particular candidate's identifying information (e.g., name, alias, social security number, contact information, criminal record, etc.) and associated test results for that particular candidate (e.g., cutting speed, cutting test time, etc.). Moreover, the employer account 84 can include information about a particular employer (e.g., employer name, alias, contact information, etc.).

In some embodiments, the terminals 12a, 12b, 12c, 12n can be configured as “Candidate Terminals,” meaning that the terminals 12a, 12b, 12c, 12n can be used by potential employees/candidates for inputting identifying information (e.g., inputting and establishing a user profile), for obtaining testing materials, for uploading test results, and/or for other uses. Also the terminals 13a, 13b, 13c, 13n can be designated as “Employer Terminals,” meaning that the terminals 13a, 13b, 13c, 13n can be used by potential employers for obtaining information (e.g., test results) of one or more candidates, for communicating directly with candidates, and/or for other uses.

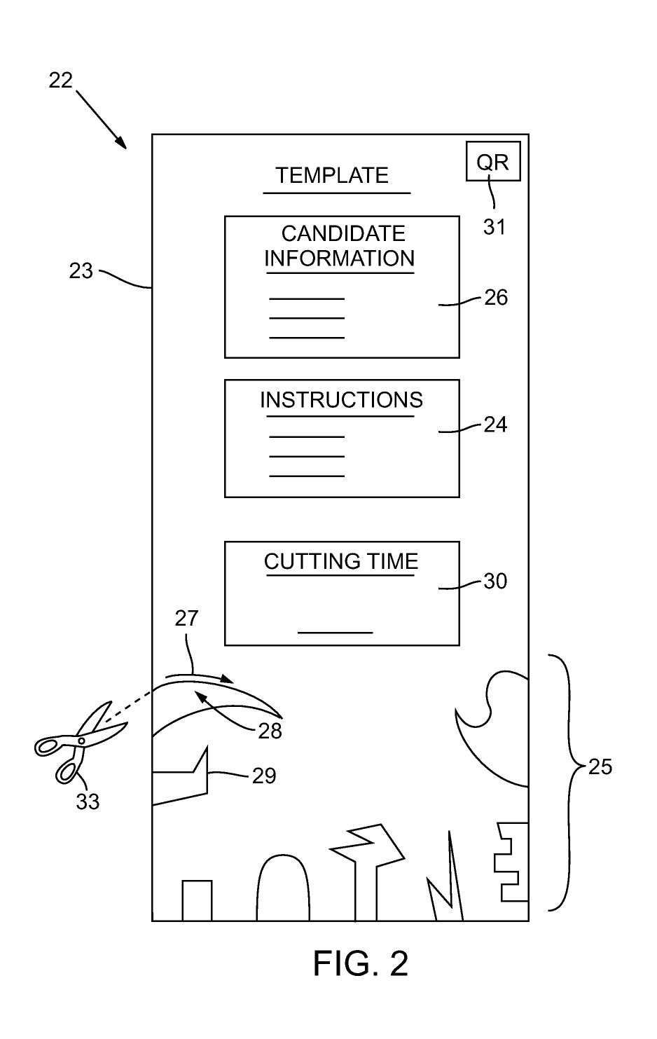

Testing can occur using a template 22, such as the exemplary template 22 shown in FIG. 2. The template 22 can be of any suitable type. In some embodiments, the template 22 can include one or more features that allow the template 22 to be cut by the candidate. The template 22 can also include one or more indications that visually indicate how to cut the template 22. Thus, the candidate can test himself or herself by cutting as indicated on the template 22. The candidate's cutting accuracy, cutting speed, test completion time, and/or other cutting information can be obtained using such testing methods.

The template 22 can also include one or more features that facilitate remote transmission between the candidate and the employer. Stated differently, the template 22 can include features that facilitate transmission between the candidate terminals 12a, 12b, 12c, 12n, the server 11, and/or the employer terminals 13a, 13b, 13c, 13n. It will be appreciated that the template 22 shown in FIG. 2 is merely an exemplary embodiment, and the template 22 could be different without departing from the scope of the present disclosure.

As shown in FIG. 2, the template 22 can be a sheet of paper, cardstock, fabric, or other material. The template 22 can also include one or more edges 23. For example, the template 22 can be a sheet of paper with a rectangular edge 23. In some embodiments, the template 22 can be a sheet of printer-sized paper (e.g., paper measuring 8.5 inches by 11 inches, A4 size paper, or other size).

The template 22 can also include various types of information that is printed or otherwise included thereon. For example, the template 22 can include testing instructions 24, which explains how to take the test to the reader (e.g., the candidate). The testing instructions 24 can also explain how to transmit the test results from one of the terminals 12a-12n to the server 11 and/or the terminals 13a-13n.

The template 22 can also include identifying information 26 of the candidate that can uniquely identify the particular candidate. The identifying information 26 can be a unique identifier of a particular candidate and can include any suitable identifying information, such as name, alias, codename, address, social security number, phone number, work experience, or other information. The identifying information 26 can be input by the candidate using the input device 18 and automatically printed on the template 22 in some embodiments, or the candidate can manually input this information 26 on the template 22.

Moreover, the template 22 can include a testing area 25 that can be cut for testing the candidate's cutting skills. The testing area 25 can be configured for testing the candidate in various ways. The testing area 25 can include at least one visually apparent indication of how to cut the template 22. The indication can indicate to the candidate where to cut the template 22, a path for cutting the template 22, a particular shape to cut from the template 22, etc.

For example, the testing area 25 can include one or more lines 29 that designate outlined areas 28 of the template 22. At least one line 29 can extend inward from the edge 23 of the template 22 in some embodiments. Stated differently, the line 29 can include at least one end that terminates at the edge 23. Also, the line 29 can be configured such that a first end of the line 29 terminates at the edge 23 and an opposite second end of the line 29 also terminates at the edge 23. The lines 29 and, thus, the outlined areas 28 can be substantially straight or curved, angular, jagged or smooth, or can have any other suitable shape. The outlined areas 28 can also be of any suitable size. Moreover, there can be any suitable number of outlined areas 28. As will be discussed the lines 29 can indicate a predetermined path (indicated by arrow 27) along which the candidate can cut the template 22 for testing purposes. Although the arrow 27 is directed away from the edge 23 in FIG. 2, it will be appreciated that the term “predetermined path” should be taken generally to mean toward or away from the edge 23 in the embodiments shown.

The template 22 can further include a time entry block 30, which documents the time it takes the candidate to cut out one or more of the outlined areas 28 from the template 28 during testing. In some embodiments, the candidate can time themselves during the cutting test and manually enter the time in the time entry block 30. In other embodiments, the time can be automatically entered, for example, by the respective candidate terminal (e.g., candidate terminal 12a).

Moreover, in some embodiments, the template 22 can also include a unique HD barcode, QR code, symbol, or other security mark 31 that is associated with the particular candidate. As such, use of the template 22 can be restricted for use only by the particular candidate. Stated differently, if a third party copies the template 22 without authorization and attempts to use the template 22, the security mark 31 can be used to identify it as a counterfeit template 22. In some embodiments, the security mark 31 can also be associated with the identifying information 26 and/or other information included in the candidate profile 82 for a particular candidate.

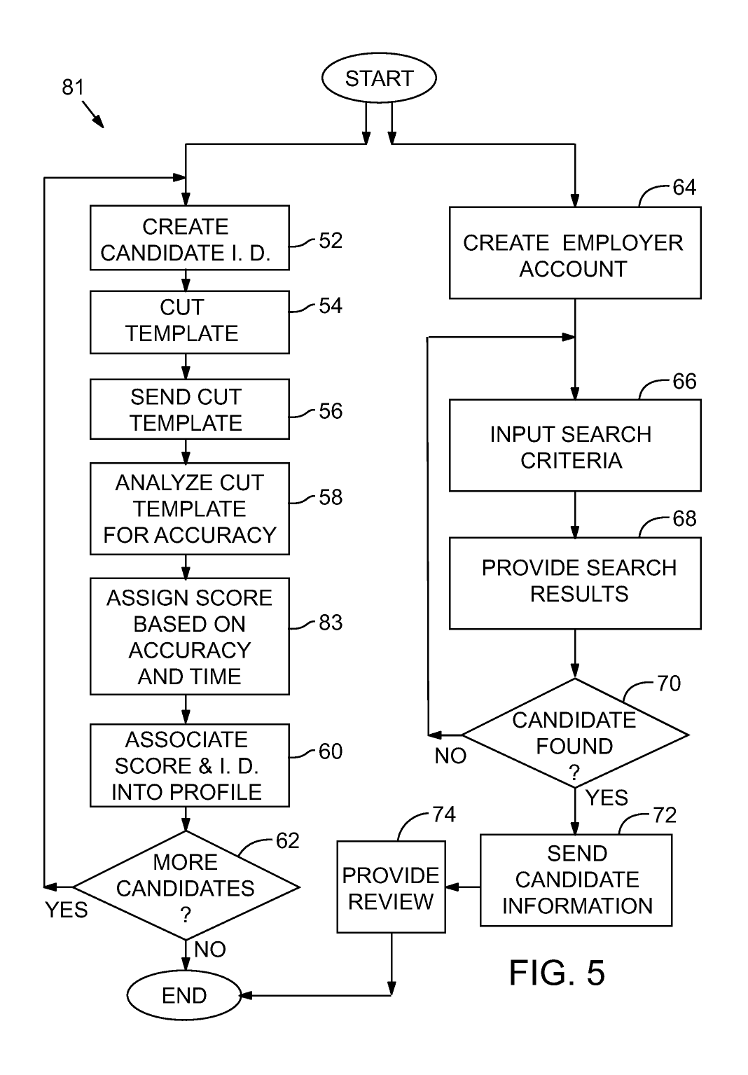

A method 81 of using the system 10 will now be discussed with reference to FIG. 5 according to exemplary embodiments. It will be appreciated that the method 81 can vary from that shown in FIG. 5. For example, the order of steps can vary. Also, some steps can occur simultaneously. Moreover, some steps can be added or eliminated without departing from the scope of the present disclosure.

The method 81 can begin in block 52, wherein a candidate creates an account within the system 10 and provides an identifier (here “candidate I.D.”). Assuming the candidate is using the terminal 12a, the candidate can access and begin using the system 10 by creating a candidate I.D. within the system using the input device 18. Specifically, the candidate can input a name (e.g., the candidate's real name or other anonymous identifier), address or other contact information, work experience, references, or other information that identifies the particular candidate. The processor 21 can process this information and send the information to the server 11 via the communication device 23 to be stored in the database 17. In some embodiments, the candidate I.D. can be password protected. Also, in some embodiments, the system 10 can require that the candidate pay a monetary fee before the system 10 allows the candidate to create the I.D.

In some embodiments, the system 10 can then provide a template 22 to the candidate. For example, the server 11 can transmit a copy of the template 22 to the terminal 12a. Then, the template 22 can be printed by the candidate using the output device 20 of the terminal 12a. In some embodiments, a fee may be charged for the delivery of the template 22 to the terminal 12a. In other embodiments, multiple hard copies of the template 22 can be available near the terminal 12a, and the candidate can receive one of the copies for testing purposes. In still additional embodiments, the server 11 can receive the user profile created in block 52, and a hard copy of the template 22 can be sent to the candidate (e.g., to the candidate's residence address) as a result.

Next, in block 54, the candidate can perform the test using the template 22. As shown in FIG. 2, the candidate can use a cutting tool 33, such as scissors, to cut the template 22 along the lines 29 and cut out each of the outlined areas 28 from the template 22. The cutting tool 33 can be provided by the candidate, or the cutting tool 33 can be publicly available at the terminal 12a.

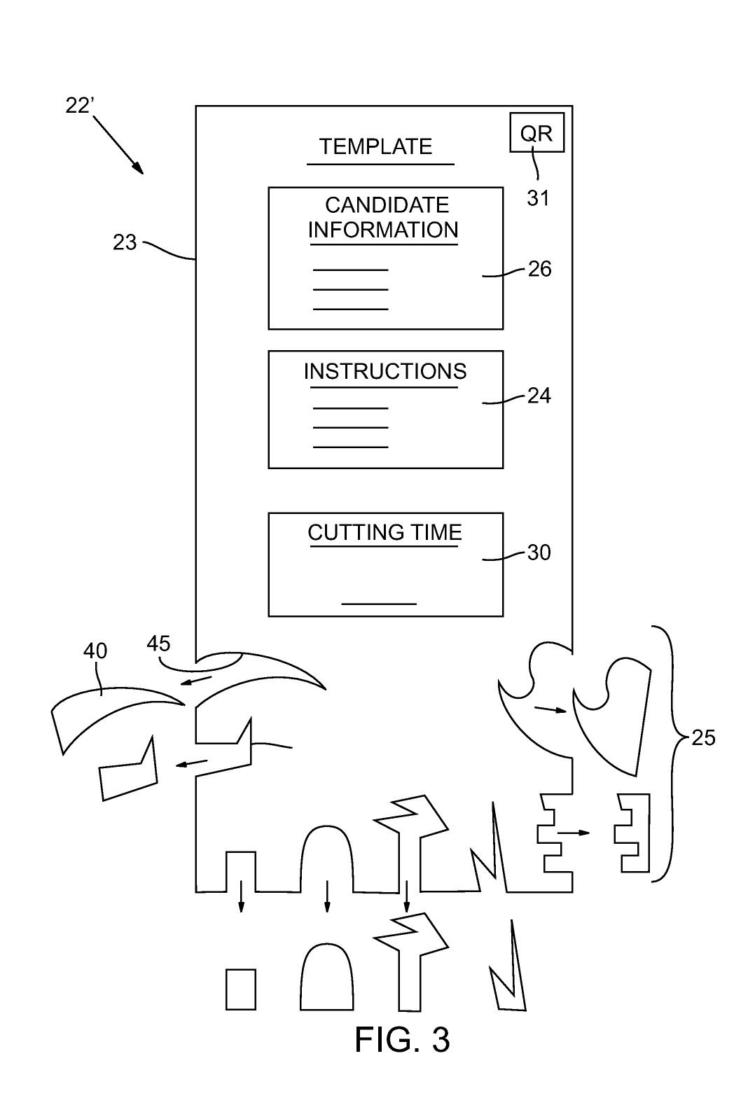

Once the candidate has completed the test, a number of cutouts 40 can be formed, leaving a cut template 22′ as shown in FIG. 3. It will be appreciated that by cutting out the cutouts 40, the cut template 22′ can be left with a number of cut edges 45 as shown in FIG. 3. The candidate can attempt to cut accurately along the lines 29 and cut each of the outlined areas 28 as fast as possible. Thus, the cut edges 45 shown in FIG. 3 may or may not coincide with the lines 29 shown in FIG. 2, depending on the candidate's cutting accuracy.

The candidate can be timed to see how long it takes to completely cut out each of the cutouts 40 from the template 22. For example, the candidate (or another individual) can use a stopwatch or other timepiece to determine how long it takes the candidate to cut out each of the cutouts 40 from the template 22. In additional embodiments, the respective candidate terminal (here terminal 12a) can include a timer that indicates the time it takes to cut out each of the cutouts 40. Furthermore, in some embodiments, the terminal 12a can automatically record the candidate's cutting time on the cut template 22′.

Once the test is complete, the method 81 can continue in block 56. In block 56, the candidate can send out the cut template 22′ so that the test can be assessed. In some embodiments, the candidate can use the terminal 12a to send the cut template 22′ back to the server 11. For example, the candidate can electronically scan the cut template 22′ using the input device 18 and send an electronic copy of the cut template 22′ back to the server 11. In other embodiments, the cut template 22′ can be sent through the mail, can be physically shipped, or otherwise transmitted out.

It will be appreciated that the cut edges 45 included on the cut template 22′ can represent information about the candidate's cutting accuracy. Thus, block 56 of the method 81 includes sending information about the candidate's cutting accuracy from the terminal 12a to the server 11. Also, other information can be transmitted from the terminal 12a to the server 11 in block 56 of the method 81. For example, additional information can include the time recorded in the time entry block 30, the identifying information 26, or other information included on the cut template 22′. In some embodiments, the server 11 can use text recognition software to read the recorded time from the time entry block 30. In other embodiments, the server 11 can receive the time more directly from the candidate terminal 12a.

Next, in block 58, the server 11 can analyze the cut template 22′ and assess the candidate's accuracy. For example, as shown in FIG. 1, the comparator 15 can have access to a master copy of the template 22. This can be a copy of the uncut template 22 of the type shown in FIG. 2. In order to analyze the candidate's cut template 22′ for accuracy, the server 11 can compare the master copy of the template 22 to the cut template 22′. For example, the comparator 15 can electronically overlay the template 22 and the cut template 22′ and analyze how much of the cut template 22′ was cut inside the lines 29 and/or how much of the cut template 22′ was cut outside the lines 29.

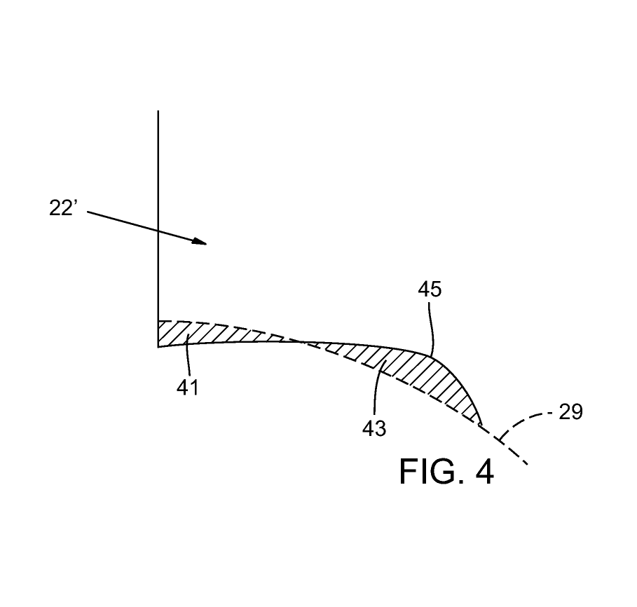

An example of this comparison is illustrated in FIG. 4. The comparator 15 of the server 11 can electronically overlay the cut template 22′ received in block 56 to the master copy of the template 22. The cut edges 45 included on the cut template 22′ can be compared to the respective lines 29 included on the original, uncut template 22. One of the lines 29 is indicated in FIG. 4 with a broken line. Since the candidate is unlikely to cut exactly along the actual line 29, the comparator 15 is likely to detect one or more zones that are defined between the cut edge 45 and the original line 29. For example, in the embodiments of FIG. 4, the comparator 15 can detect a first zone 41, which is a portion of the template 22 that was cut inside the line 29. The comparator 15 can also detect a second zone 43, which is a portion of the template 22 that was cut outside the line 29. In some embodiments, the processor 80 of the server 11 can add the total area of the first zone 41 and the second zone 43 for purposes of determining the candidate's cutting accuracy.

Next, in block 83 of the method 81, the server 11 can assign a test score according to the determined cutting accuracy, the testing time included in the time entry block 30, and/or other factors. The scoring system can have any suitable scale, such as a scale from “1” to “10”. A score of “10” can represent high accuracy and low test-taking time. More specifically, if the total area of the first zone 41 and the second zone 43 is close to zero and the test taking time is relatively low, the server can assign a score close to “10”. In contrast, if the server 11 detects highly inaccurate cutting of the cut template 22′ and the cutting time recorded in the time entry block 30 is relatively high, the server 11 can assign a score closer to “1”. The score assigned in block 83 can also be affected by other factors, some of which will be discussed below.

Next, in block 60 of the method 81, the server 11 can associate the test results (e.g., the score assigned in block 83) with the candidate I.D. information created in block 52. Also, in some embodiments, the server 11 can obtain identifying information 26 included on the cut template 22′ (e.g., using text-recognition software). This identifying information 26 can be further associated with the score assigned in block 83 and with the candidate I.D. information created in block 52. Moreover, in some embodiments, the security mark 31 included on the cut template 22′ can be associated with the identifying information 26, the score assigned in block 83, and with the candidate I.D. information created in block 52. This associated data can form the candidate profile 82 stored in the database 17 on the server 11. Thus, this candidate profile 82 can include the candidate's name, alias, contact information, social security number, criminal record, employment history, or other information submitted by the candidate. The profile 82 can also include the candidate's test score relating to the candidate's cutting speed and cutting accuracy.

Furthermore, in block 62, it can be determined whether there are additional candidates available to take the test. If not, then the method can end. However, if there are additional candidates (block 62 answered affirmatively), the method 81 can loop back to block 52. Additional candidate I.D.s can be created for those additional candidates. Then, those candidates can take respective tests using the same template 22. Test information (e.g., cutting accuracy and cutting time) can be associated with the respective user I.D. to create additional candidate profiles, and the profiles can be saved in the database 17.

It will be appreciated that each candidate can receive the same template 22 for testing. Thus, the cutting test can be standardized among a number of different candidates.

Additional features of the method 81 can allow potential employers to access the database 17 and identify suitable potential candidates for employment. For example, method 81 can include block 64, wherein a potential employer can create a respective employer account 84. In some embodiments, the system 10 can require a fee before the system 10 allows the employer account 84 to be created. The employer account 84 can include the employer name, codename, contact information, tax identification information, or other suitable information. The employer account 84 can then be saved in the database 17 of the server 11 as shown in FIG. 1. The employer can use any of the employer terminals 13a, 13b, 13c, 13n shown in FIG. 1. For purposes of discussion, it will be assumed that the employer is using terminal 13a.

Next, in block 66, the employer can input search criteria using the input device 55. The employer can command the terminal 13a to send a request to the server 11 with any suitable search criteria. For instance, the employer can request the server 11 to send back all candidate profiles stored within the database 17 with an associated score that is above a predetermined minimum. The search criteria can also include other restrictions, such as a request to send candidate profiles listing certain zip codes. In additional embodiments, the employer can additionally request the server 11 to send candidate profiles that include certain keywords, such as certain years of experience that might be included within the candidate's profile 82.

In response to the request of block 66, the server 11 can reply to the terminal 13a in block 68. Specifically, the server 11 can send candidate profiles of the candidates that satisfy the search request sent in block 66. The server 11 can also block transfer of the candidate profiles that fail to satisfy the search request sent in block 66. The terminal 13a can then output the candidate profiles, for example, by displaying the candidate profiles and/or otherwise outputting the candidate profiles using the output device 57 of the terminal 13a.

Next, it is determined in block 70 whether the employer has found one or more suitable candidates according to the information sent in block 68. If the employer has not found any suitable potential candidates (block 70 answered negatively), then the method 81 can loop back to 66, and the employer can input different search criteria. However, if one or more potential candidates has been identified (block 70 answered positively), then the method 81 can continue in block 72.

In block 72, the employer can use the terminal 13a to further request the server 11 to send more detailed contact information about the candidates identified in block 68. Using this information, the employer can contact the candidates, and the employer can interview and possibly hire at least one of those candidates. In other embodiments, once the employer finds suitable candidates, the employer can instruct the server 11 to send the candidates notification that the employer is interested in interviewing and/or hiring them, and the candidate can take the initiative to further contact the employer.

Moreover, in some embodiments, the terminals 13a-13n can be used by an employer to update the candidate profiles 82 stored in the database 17 at the server 11. For instance, in block 74, if an employer knows of a particular candidate and would like to provide opinions about that candidate's work habits, work ethic, etc., the employer can use one of the terminals 13a-13n to communicate those comments to the server 11. The server 11 can, in turn, update the corresponding candidate profile with those comments in the database 17.

In some embodiments, the server 11 can track which candidates are hired by particular employers. Thus, the server 11 can send those employers an inquiry about those candidates that were hired. The inquiry can include a survey about the candidate. Using the survey results, the server 11 can automatically adjust the candidate's profile 82. For example, the score assigned in block 83 of the method 81 can be adjusted using these survey results. In other embodiments, the user profile 82 can store the survey results or other employer feedback without adjusting the score. Accordingly, the system 10 can keep the candidate profiles 82 up-to-date based on actual work performance.

Also, in some embodiments, employers can write reviews of particular candidates, and those reviews can be saved in the corresponding candidate profile 82. Other employers can review those comments when deciding whether to hire that candidate.

Furthermore, the system 10 can further perform background checks on the candidates. For example, the server 11 can use the candidate's identifying information to search publicly available arrest records, etc. This information can be included in the respective candidate profile 82. In some embodiments, the server 11 can adjust the score assigned in block 83 of the method 81 based on this background check. For example, the server 11 can have access to an algorithm that recalculates the score as a function of the number and/or severity of criminal convictions. Moreover, in some embodiments, the profile 82 can be deleted if the accumulated average candidate score drops below a predetermined level as a function of the negative numeric value of the criminal history.

In some embodiments, the system 10 can be configured such that the candidates and/or the potential employers pay to use the system 10. For example, in some embodiments, the system 10 can be configured such that the candidates pay a fee to gain access of use to one of the candidate terminals 12a, 12b, 12c, 12n. Such a fee can also be required before the candidate is allowed to exchange information with the server 11 and/or one of the employer terminals 13a, 13b, 13c, 13n. Likewise, the system 10 can be similarly constructed such that potential employers need to pay a fee before accessing the employer terminals 13a, 13b, 13c, 13n and/or before exchanging information with the server 11 and/or the candidate terminals 12a, 12b, 12c, 12n. Moreover, in some embodiments, the fees can be implemented as a subscription fee that is paid by the candidate and/or the employer for access to the system 10. Still further, in some embodiments, the fees can be a la carte fees that are required for performing particular tasks, sending particular requests, or otherwise utilizing certain features of the system 10. These fees can be collected by a third party in some embodiments.

Accordingly, the system 10 and the method 81 can be an effective tool for testing potential employees in the use of cutting tools. The system 10 and method 81 can greatly facilitate the employer's abilities to find suitable candidates, to provide reviews of candidates, and for other uses.

The foregoing description of the embodiments has been provided for purposes of illustration and description. It is not intended to be exhaustive or to limit the disclosure. Individual elements or features of a particular embodiment are generally not limited to that particular embodiment, but where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

We claim:

1. A system for remote communication of information relating to cutting operations, the system comprising:
a template that is configured for cutting by a person, the template including an indication that indicates a predetermined path for cutting of the template;
a first computerized device including an input device configured to input cutting information, the cutting information relating to cutting of the template along the predetermined path;
a second computerized device that is remote from the first computerized device, the second computerized device configured to receive the cutting information; and
a communications device configured to provide communication between the first computerized device and the second computerized device to allow the cutting information to be sent from the first computerized device to the second computerized device.

2. The system of claim 1, wherein the indication is at least one line included on the template, the at least one line extending along the predetermined path.

3. The system of claim 2, wherein the at least one line includes at least one of a curved line, an angular line, and a substantially straight line.

4. The system of claim 2, wherein the template includes an edge, and wherein the at least one line terminates at the edge.

5. The system of claim 1, wherein the template further includes instructions for cutting along the predetermined path.

6. The system of claim 1, wherein the cutting information includes a time necessary for completing a cutting of the template along the predetermined path.

7. The system of claim 1, wherein the template is configured to be cut and transformed into a cut template having a cut edge, wherein the cutting information is a copy of the cut template and the cut edge, wherein the communications device is configured to transmit the copy of the cut template with the cut edge, and wherein the second computerized device includes a comparator that is configured to compare the cut edge with the predetermined cutting path of the template to determine an accuracy of cutting the template along the predetermined path;

8. The system of claim 1, wherein the input device of the first computerized device is also configured to input an identifier of the person, wherein the communications device is configured to transfer the identifier from the first computerized device to the second computerized device.

9. The system of claim 1, further comprising a third computerized device, the third computerized device being in communication with the second computerized device, the third computerized device configured to send a request to the second computerized device to provide the cutting information to the third computerized device.

10. A method of remotely communicating information relating to cutting operations, the method comprising:
providing a template, the template including an indication that indicates a predetermined path for cutting the template;
receiving cutting information by a first computerized device, the cutting information relating to cutting of the template by a first person along the predetermined path;
transferring the cutting information from the first computerized device to a second computerized device that is remote from the first computerized device; and
outputting the cutting information from the second computerized device.

11. The method of claim 10, wherein the indication is at least one line included on the template, the at least one line extending along the predetermined path.

12. The method of claim 11, wherein the template includes an edge, and wherein the at least one line terminates at the edge.

13. The method of claim 10, wherein the cutting information includes a time necessary for the first person to complete a cutting of the template along the predetermined path, wherein receiving cutting information includes receiving the time, wherein receiving cutting information also includes receiving a copy of the template which has been cut along the predetermined path to form a cut edge, wherein transferring the cutting information includes transferring the time and the copy from the first computerized device to the second computerized device.

14. The method of claim 13, further comprising comparing, by the second computerized device, the cut edge of the copy to the predetermined path included on the template to determine an accuracy of cutting the template along the predetermined path.

15. The method of claim 14, further comprising assigning a score according to the time and the accuracy.

16. The method of claim 10, further comprising receiving an identifier of the first person by the first computerized device, transferring the identifier from the first computerized device to the second computerized device, associating the cutting information with the identifier to form a profile, and outputting the profile by the second computerized device.

17. The method of claim 10, wherein providing the template includes providing the template using an output device of the first computerized device.

18. The method of claim 10, further comprising sending a request from a third computerized device to the second computerized device, the request including a request to transfer the cutting information from the second computerized device to the third computerized device, and further comprising transferring the cutting information from the second computerized device to the third computerized device in response to the request.

19. A method of remotely communicating information relating to cutting operations, the method comprising:
providing a first candidate computer, a second candidate computer, and at least one employer computer, the first and second candidate computers in remote communication with the at least one employer computer, the first candidate computer including a first input device, the second candidate computer including a second input device, the at least one employer computer including an output device;
providing a first template to a first candidate and a second template to a second candidate, the first and second templates both including an indication that indicates a predetermined path for cutting the respective template;
allowing the first candidate to cut the first template along the predetermined path and allowing the second candidate to cut the second template along the predetermined path;
receiving, by the first input device of the first candidate computer, a first cutting information and a first identifier of the first candidate, the first cutting information relating to cutting of the first template by the first candidate along the predetermined path;
associating the first identifier with the first cutting information to create a first profile of the first candidate;
receiving, by the second input device of the second candidate computer, a second cutting information and a second identifier of the second candidate, the second cutting information relating to cutting of the second template by the second candidate along the predetermined path;
associating the second identifier with the second cutting information to create a second profile of the second candidate;
transferring the first profile and the second profile to the at least one employer computer; and
outputting at least one of the first profile and the second profile using the output device of the at least one employer computer.

20. The method of claim 19, further comprising sending, by the at least one employer computer, a search request with a search criteria, and wherein outputting the at least one of the first profile and the second profile includes outputting one of the first profile and the second profile that satisfies the search criteria, and further comprising blocking transfer of the other of the first profile and the second profile that fails to satisfy the search criteria.
